(19) United States
(12) Patent Application Publication
(10) Pub. No.: US 2004/0163498 A1
(43) Pub. Date: Aug. 26, 2004

(54) Structure of a ratchet wrench

(76) Inventor: Lin-Lang Liu, Taichung (TW)

Correspondence Address: Lin-Lang Liu, PO Box 82-144, TAIPEI, TW

(21) Appl. No.: 10/119,768

(22) Filed: Apr. 11, 2002

(51) Int. Cl. B25B 13/46

(52) U.S. Cl. 81/60

(57) ABSTRACT

An improved structure of a ratchet wrench is disclosed. The ratchet wrench comprises a handle and a sleeve module at one end thereof, characterized in that the sleeve module is formed as a circular mount at the end portion of the handle, and the inner diameter of the circular mount is protruded with an urging edge, and the urging edge is provided with a sleeve having a ratchet face at the external circumferential edge, the handle, corresponding to the circular mount, is provided with an inter-communication crescent-shaped slot and the rear side of the crescent-shaped slot is extended with a cavity, a crescent-shaped ratchet block is located within the crescent slot, and the teeth and curvature of the crescent-shaped ratchet block and the ratchet face are corresponding to each other, a spring having restoration force is located between the crescent ratchet block and the cavity, thereby an improved ratchet wrench with a greater torque is obtained.

### BACKGROUND OF THE INVENTION

(a) Technical Field of the Invention

The present invention relates to a ratchet wrench, and in particular, to a ratchet wrench structure having a crescent-shaped ratchet block to engage with that of the sleeve so as to provide a better torque to the ratchet wrench.

(b) Description of the Prior Art

FIG. 1 shows a conventional ratchet wrench having a handle 10 at one end and a sleeve module 20. The sleeve module 20 includes sleeve 21 which can be engaged at external edge face with a bolt or nut. A cavity 23 is formed at the inner edge at one end of the sleeve module 20, and a smaller ratchet block 24 is positioned within the cavity 23 and the rear side of the ratchet block 24 is supported by an elastic element 25.

When the ratchet wrench turns clockwise, the highest point of the ratchet block 24 is engaged with the ratchet face 22 of the sleeve 21, and thus the sleeve 21 can tight a bolt or screw nut. If the ratchet wrench rotates in a counter-clockwise direction, the ratchet block 24 is pushed to the wider side of the cavity 23 such that the sleeve 21 does not restricted by the ratchet block 24 and the sleeve 21 rotates freely and the bolt or screw nut is not rotated. The drawbacks of the conventional ratchet wrench are that the specification of a sleeve 21 is always specific and the user needs to bring a number of wrenches. Therefore, it incurs cost of the wrenches and brings inconvenience to the user. Besides, if the ratchet face 22 of the sleeve 21 is worn, the entire wrench has to be replaced. Furthermore, the engagement of the ratchet block 24 and the ratchet face 22 of the sleeve 21 is restricted by the protruded shape of the ratchet block 24. The sleeve and the sleeve 21 can have only one single engagement and the resistance to the torque is insufficient. Thus, the ratchet face 22 or the ratchet block 24 is frequently damaged.

### SUMMARY OF THE INVENTION

Accordingly, it is an object of the present invention to provide an improved structure of a ratchet wrench having a handle and a sleeve module at one end thereof, characterized in that the sleeve module is formed as a circular mount at the end portion of the handle, and the inner diameter of the circular mount is protruded with an urging edge, and the urging edge is provided with a sleeve having a ratchet face at the external circumferential edge, the handle, corresponding to the circular mount, is provided with an inter-communication crescent-shaped slot and the rear side of the crescent-shaped slot is extended with a cavity, a crescent-shaped ratchet block is located within the crescent slot, and the teeth and curvature of the crescent-shaped ratchet block and the ratchet face are corresponding to each other, a spring having restoration force is located between the crescent ratchet block and the cavity, thereby an improved ratchet wrench with a greater torque is obtained.

Other objects, advantages and applications of the present invention will become apparent when the detailed description of the present invention is lead in conjunction with the accompanying drawings.

### BRIEF DESCRIPTION OF THE DRAWINGS

FIG. 1 is a top view of a conventional wrench.

FIG. 2 is an exploded perspective view, showing the relative positions of the individual components in accordance with the present invention.

FIG. 3A illustrates an schematically the replacement of the sleeve in accordance with the present invention.

FIG. 3B is a partial top view of the ratchet wrench, showing the sleeve in accordance with the present invention.

FIG. 4 is a sectional view showing the action of the ratchet sleeve in accordance with the present invention.

FIG. 5 is perspective exploded view of another preferred embodiment of the present invention.

FIG. 6 is a partial sectional view of another preferred embodiment of the present invention.

FIG. 7 is a further preferred embodiment of the present invention.

FIG. 8 is a partial sectional view of a further preferred embodiment of the present invention.

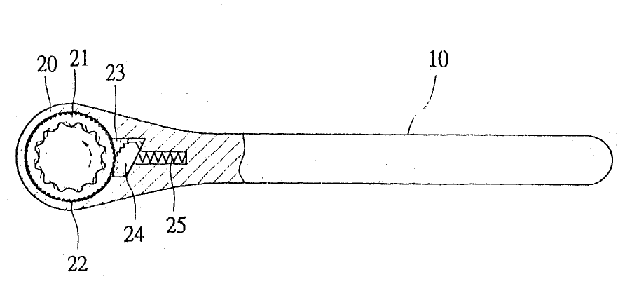

### DETAILED DESCRIPTION OF THE PREFERRED EMBODIMENT

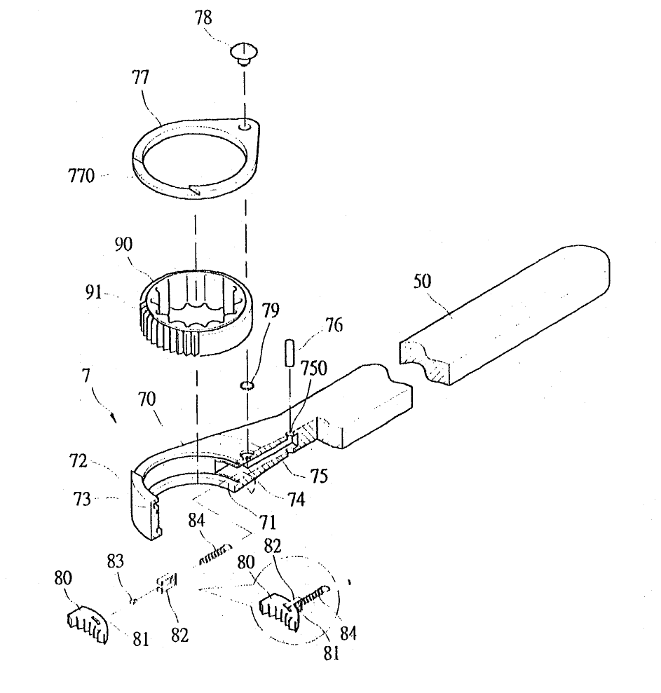

Referring to FIG. 2, there is shown an improved structure of a ratchet wrench in accordance with the present invention. The ratchet wrench includes a handle 50 and a sleeve module 7 positioned at one end of the handle 50.

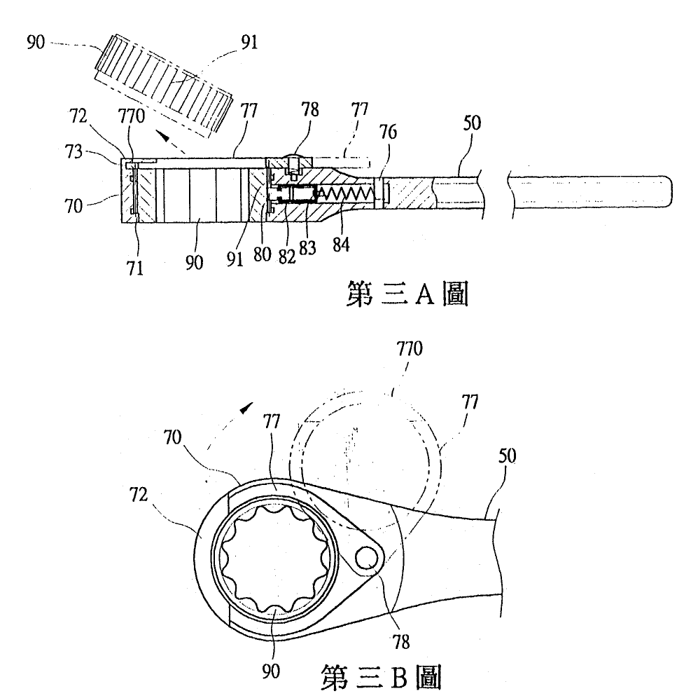

In accordance with the present invention, the sleeve module 7 is located at one end of the handle 50 and includes a circular mount 70 for positioning of a limiting plate 77 having a smaller inner diameter as compared to that of the circular mount 70. The inner bottom edge of the circular mount 70 is extended to form an urging edge 71 to correspondingly hold a sleeve 90. The top face of the circular mount 70 is protrudingly mounted with a pressing block 72 having a recess 73. The handle 50, corresponding to the inner radius of the circular mount 70 is provided with an inter-communication crescent-shaped slot 74 to hold a crescent-shaped ratchet block 80. The rear side of the crescent-shaped slot 74 is extended to form a cavity 75. The handle 50, corresponding to the bottom end of the cavity 75, is also provided with a through hole 750 being in communication in an axial direction for the insertion of a fixing bolt 76. The limiting plate 77 is pivotally mounted to the handle 50, corresponding to the circular mount 70 by means of a pivotal bolt 78 and a spring 79 such that the limiting plate 77 is pivotally rotated (as shown in FIG. 3B). The free end of the limiting plate 77 is a protruded engaging section 770 (as shown in FIG. 3A) which can be mounted to the recess 73 of the circular mount 70.

The two lateral sides of the crescent-shaped ratchet block 80 within the crescent-shaped slot 74 are formed into corresponding sliding slot 81 for slidably fastening of a “C”-shaped fastening block 82. A spring 84 is mounted to the fastening block 82 using a fastening bolt 83. The other end of the spring 84 is mounted to the bottom end of the cavity 75 by means of a fixing bolt 76 such that the crescent-shaped ratchet block 80 can produce an automatic restoration function. The inner diameter of the sleeve 90 within the circular mount 70 can be various types of specification, and the external circumferential edge of the sleeve 90 is formed into a ratchet face 91. The teeth and curvatures of the ratchet face 91 and that of ratchet block 80 are corresponding to each other, such that the crescent-shaped ratchet block 80 can be fully engaged with the ratchet face 91 of the sleeve 90. Thus, a ratchet wrench with large torque for general purposes is obtained.

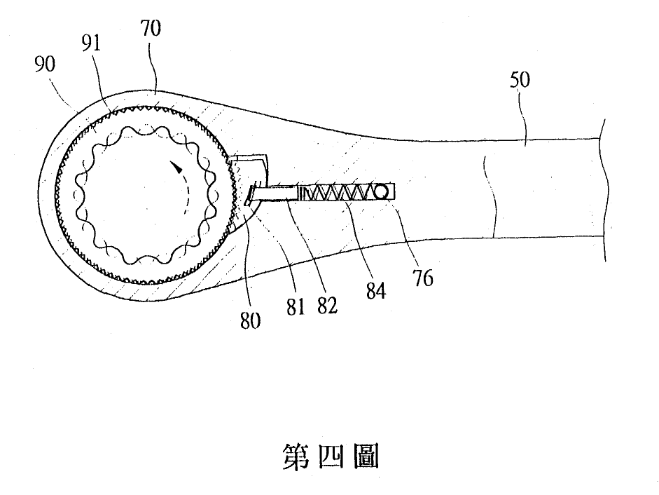

In application, as shown in FIGS. 3 and 4, when a different size of sleeve 90 is used, the limiting plate 77 is moved to one side and the sleeve 90 is taken out or unloaded. Anew sleeve 90 is then placed into the circular mount 70 and let the ratchet face 91 of the sleeve 90 is engaged with the crescent-shaped ratchet block 80. Finally, the limiting plate 77 is pushed back to its original position, and the protruded engaging section 770 and the recess 73 are in engagement. Thus, in accordance with the present invention, the replacement of sleeve 90 is rapid, and when the sleeve module 7 is used to rotate a screw bolt or a screw nut, the direction of rotation is in a clockwise direction, and the ratchet face 91 of the sleeve 90 can drive the crescent-shaped ratchet block 80 forward so that each tooth of the crescent-shaped ratchet block 80 can fully engaged with the ratchet face 91 of the sleeve 90. Thus, such rotation can withstand a larger torque. When the ratchet wrench rotates in a counter-clockwise direction, the crescent-shaped ratchet block 80 is driven by the ratchet face 91 of the sleeve 90 and the crescent-shaped ratchet block 80 is dislocated, and the sleeve 90 is free to rotate without engagement. This will facilitate the operation of restoration of the ratchet wrench. At the same time, due to the formation of the sliding slot 81 on the crescent-shaped ratchet block 80, the sliding of the crescent-shaped ratchet block 80 can be achieved by the sliding slot 81. As a result, the fastening block 82 and the spring 84 do not need to be moved. Thus, the cavity 75 can be designed with a smaller inner diameter (as shown in FIG. 4) to enhance the strength of the handle 50.

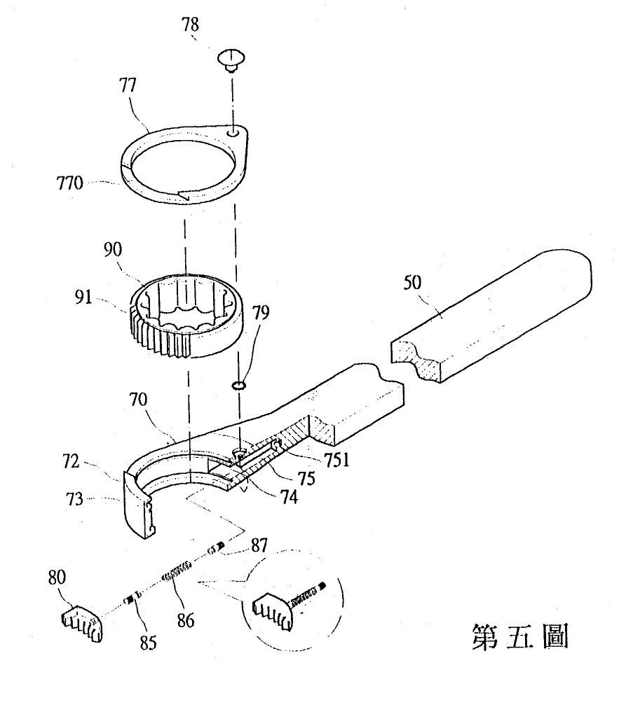

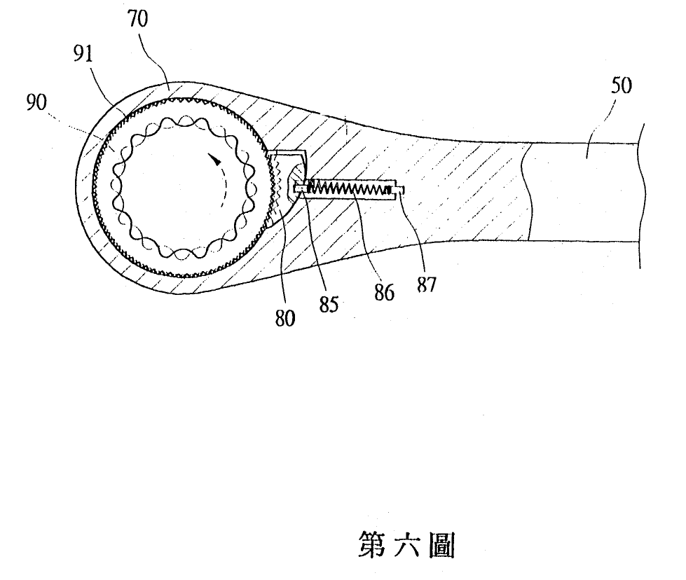

FIGS. 5 and 6 illustrate another preferred embodiment of the present invention. The crescent-shaped ratchet block 80 is located at the bottom end by means of a fixing bolt 85. A spring 85 is provided to the fixing bolt 85, and the other end of the spring 86 has a fixing bolt 87, and the bottom end of the cavity 75 is provided with a bolt hole 751 so that the fixing bolt 87 can be positioned at the bottom end of the cavity 75. Thus, the crescent-shaped ratchet block 80 can be located within the crescent-shaped slot 74 and to provide clockwise and counter-clockwise rotation together with the sleeve 90.

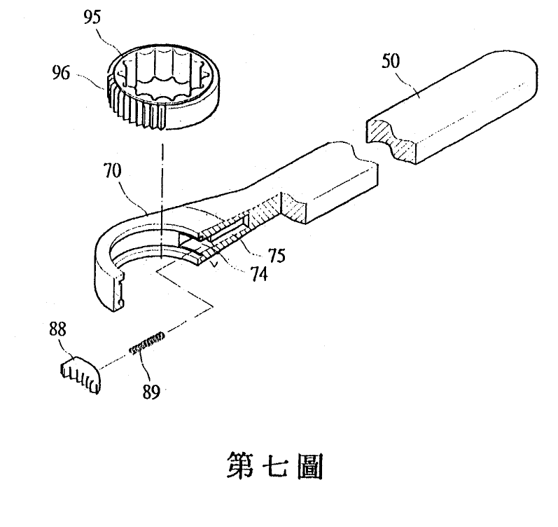

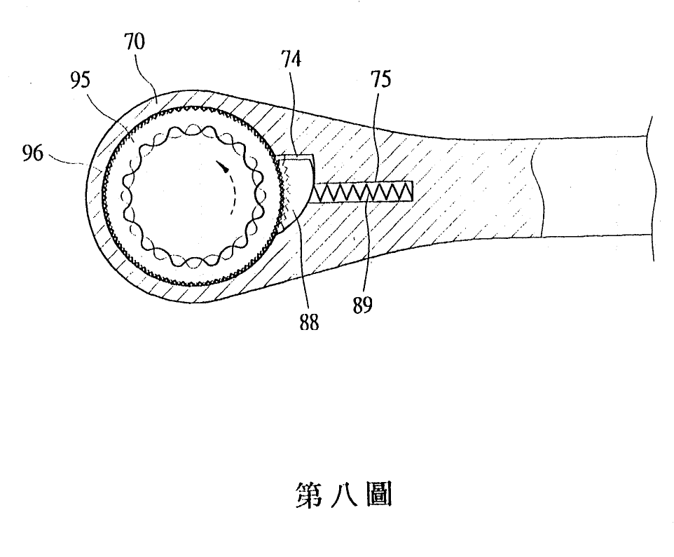

FIGS. 7 and 8 show a further preferred embodiment of the present invention. The sleeve module 7 is made into specific type which cannot be changed or replaced. The crescent-shaped ratchet block 88 is located within the crescent-shaped slot 74 of the handle 50, and the crescent-shaped ratchet block 88 at the rear end of the cavity 75 urges a spring 89 being used as a restoration device. The sleeve 95 having a ratchet face 96 at the external edge thereof is mounted within the circular mount 70 of the handle 50. At the same time, the curvatures and the teeth of the crescent-shaped ratchet block 88 and the ratchet face 96 are corresponding to each other. Thus, when the wrench rotates in a clockwise direction, the crescent-shaped ratchet block 88 is fully engaged with the ratchet face 96 of the sleeve 95. Therefore, the torque of the wrench is effectively improved.

The advantages of the present invention are that:

(1) The sleeve 90 can be replaced in accordance with the needs of the users, and the replacement operation is convenient and rapid.

(2) Due to the design of the crescent-shaped ratchet block 80, during the rotation of the wrench the individual tooth of the ratchet block 80 will fully engage with the ratchet face 91 of the sleeve. Thus the engagement of teeth proves the turning torque of the wrench.

(3) As the sleeve 90 can be replaced, one ratchet wrench with a plurality of sleeves of various specifications can provide fastening of bolts and nuts. Therefore, the purchasing cost of such device is reduced to a maximum.

While the invention has been described with respect to preferred embodiments, it will be clear to those skilled in the art that modifications and improvements may be made to the invention without departing from the spirit and scope of the invention. Therefore, the invention is not to be limited by the specific illustrative embodiment, but only by the scope of the appended

I claim:

1. An improved structure of a ratchet wrench having a handle and a sleeve module at one end thereof, characterized in that the sleeve module is formed as a circular mount at the end portion of the handle, and the inner diameter of the circular mount is protruded with an urging edge, and the urging edge is provided with a sleeve having a ratchet face at the external circumferential edge, the handle, corresponding to the circular mount, is provided with an inter-communication crescent-shaped slot and the rear side of the crescent-shaped slot is extended with a cavity, a crescent-shaped ratchet block is located within the crescent slot, and the teeth and curvature of the crescent-shaped ratchet block and the ratchet face are corresponding to each other, a spring having restoration force is located between the crescent ratchet block and the cavity, thereby an improved ratchet wrench with a greater torque is obtained.

2. The improved structure of a ratchet wrench of claim 1, wherein circular mount of the sleeve module utilizing a pivot bolt and the spring to mount a limiting plate having a smaller inner diameter, and the free end of the limiting plate is formed into a protruded engaging section, and the top face of the circuit mount is provided with a pressing block having a recess such that the limiting plate can engage at the recess of the circular mount.

3. The improved structure of a ratchet wrench of claim 1, wherein the two lateral sides of the crescent ratchet block are formed into corresponding sliding slot for slidably fastening with a “C-shaped” fastening block, the fastening block utilizes fastening bolt to mount the spring and the handle is formed into an axial direction communication through hole corresponding to the bottom end of the cavity for the fixing bolt to mount the spring at the other end.

4. The improved structure of a ratchet wrench of claim 1, wherein the bottom end of the crescent ratchet block utilizes a fixing bolt to mount the spring and the bottom end of the cavity is formed into a bolthole for the fixing bolt to mount the spring at the other end.

5. An improved structure of a ratchet wrench having a handle and a sleeve module at one end thereof, characterized in that the sleeve module is formed as a circular mount at the end portion of the handle, and the inner diameter of the circular mount is provided with an inter-communication crescent-shaped slot and the rear side of the crescent-shaped slot is extended with a cavity, a crescent-shaped ratchet block is located within the crescent slot, and the teeth and curvature of the crescent-shaped ratchet block and the ratchet face are corresponding to each other, a spring having restoration force is located between the crescent ratchet block and the cavity, thereby an improved ratchet wrench with a greater torque is obtained.
